(19) United States
(12) Patent Application Publication
(10) Pub. No.: US 2019/0036595 A1
(43) Pub. Date: Jan. 31, 2019

(54) APPARATUS AND METHOD FOR RELAY SELECTION

(71) Applicant: NEC CORPORATION, Tokyo (JP)

(72) Inventors: Taichi OHTSUJI, Tokyo (JP); Kazushi MURAOKA, Tokyo (JP)

(73) Assignee: NEC CORPORATION, Tokyo (JP)

(21) Appl. No.: 16/071,924

(22) PCT Filed: Dec. 15, 2016
(86) PCT No.: PCT/JP2016/087341

§ 371 Date: Jul. 23, 2018

(30) Foreign Application Priority Data
Jan. 25, 2016 (JP) 2016-011686

(51) Int. Cl. H04B 7/14; H04W 76/14; H04W 48/16; H04W 24/10; H04W 72/08

(52) U.S. Cl. CPC H04B 7/14; H04W 76/14; H04W 88/04; H04W 24/10; H04W 72/08; H04W 48/16

(57) ABSTRACT

A relay selecting entity (1, 3, 5) is configured to select at least one specific relay terminal (2) suitable for a first remote terminal (1) from among one or more relay terminals (2) while considering the number of other remote terminals connected to or communicating with each relay terminal (2). Each specific relay terminal (2) relays traffic between the first remote terminal (1) and a base station (3) through a device-to-device (D2D) link (102) between the specific relay terminal (2) and the first remote terminal (1) and through a backhaul link (101) between the specific relay terminal and the base station.

### TECHNICAL FIELD

The present disclosure relates to inter-terminal direct communication (i.e., device-to-device (D2D) communication) and, in particular, to a selection of a relay terminal.

### BACKGROUND ART

In some implementations, a radio terminal is configured to directly communicate with other radio terminals. Such communication is referred to as device-to-device (D2D) communication. The D2D communication includes at least one of direct communication and direct discovery. In some implementations, a plurality of radio terminals supporting D2D communication form a D2D communication group autonomously or under the control of a network, and perform communication with other radio terminals in the formed D2D communication group.

3GPP Release 12 specifies Proximity-based services (ProSe) (see, for example, Non-patent Literature 1). ProSe includes ProSe discovery and ProSe direct communication. ProSe discovery makes it possible to detect proximity (in proximity) of radio terminals. ProSe discovery includes direct discovery (ProSe Direct Discovery) and network-level discovery (EPC-level ProSe Discovery).

ProSe Direct Discovery is performed through a procedure in which a radio terminal capable of performing ProSe (i.e., ProSe-enabled User Equipment (UE)) detects another ProSe-enabled UE by using only the capability of a radio communication technology (e.g., Evolved Universal Terrestrial Radio Access (E-UTRA) technology) possessed by these two UEs. On the other hand, in EPC-level ProSe Discovery, a core network (i.e., Evolved Packet Core (EPC)) determines proximity of two ProSe-enabled UEs and notifies these UEs of the detection of proximity. ProSe Direct Discovery may be performed by three or more ProSe-enabled UEs.

ProSe direct communication makes it possible to establish a communication path(s) between two or more ProSe-enabled UEs existing in a direct communication range after the ProSe discovery procedure is performed. In other words, ProSe direct communication enables a ProSe-enabled UE to directly communicate with another ProSe-enabled UE, without traversing a Public Land Mobile Network (PLMN) including a base station (eNodeB). ProSe direct communication may be performed by using a radio communication technology that is also used to access a base station (eNodeB) (i.e., E-UTRA technology) or by using a wireless local area network (WLAN) radio technology (i.e., IEEE 802.11 radio technology).

ProSe direct discovery and ProSe direct communication are performed on an inter-UE direct interface. This direct interface is referred to as a PC5 interface or a sidelink. That is, ProSe direct discovery and ProSe direct communication are examples of the D2D communication. The D2D communication can be referred to as sidelink communication or peer-to-peer communication.

In 3GPP Release 12, a ProSe function communicates with a ProSe-enabled UE through a Public Land Mobile Network (PLMN) and assists ProSe discovery and ProSe direct communication. The ProSe function is a logical function that is used for PLMN-related operations required for ProSe. The functionality provided by the ProSe function includes, for example: (a) communication with third-party applications (a ProSe Application Server), (b) authentication of a UE for ProSe discovery and ProSe direct communication, (c) transmission of configuration information for ProSe discovery and ProSe direct communication (e.g., EPC-ProSe-User ID) to a UE, and (d) providing of network-level discovery (i.e., EPC-level ProSe discovery). The ProSe function may be implemented in one or more network nodes or entities. In this specification, one or more network nodes or entities that implement the ProSe function are referred to as “ProSe function entities” or “ProSe function servers”.

3GPP Release 12 further defines a partial coverage scenario where one UE is located outside the network coverage and another UE is located within the network coverage (see, for example, Sections 4.4.3, 4.5.4 and 5.4.4 of Non-Patent Literature 1). In the partial coverage scenario, the UE outside the coverage is referred to as a “remote UE”, and the UE that is in coverage and performs relaying between the remote UE and the network is referred to as a “ProSe UE-to-Network Relay”. The ProSe UE-to-Network Relay relays traffic (downlink and uplink) between the remote UE and the network (E-UTRA network (E-UTRAN) and EPC)

More specifically, the ProSe UE-to-Network Relay attaches to the network as a UE, establishes a PDN connection to communicate with a ProSe function entity or another Packet Data Network (PDN), and communicates with the ProSe function entity to start ProSe direct communication. The ProSe UE-to-Network Relay further performs the discovery procedure with the remote UE, communicates with the remote UE on the inter-UE direct interface (e.g., sidelink or PC5 interface), and relays traffic (downlink and uplink) between the remote UE and the network. When the Internet Protocol version 4 (IPv4) is used, the ProSe UE-to-Network Relay operates as a Dynamic Host Configuration Protocol Version 4 (DHCPv4) Server and Network Address Translation (NAT). When the IPv6 is used, the ProSe UE-to-Network Relay operates as a stateless DHCPv6 Relay Agent.

Further, in 3GPP Release 13, extensions of ProSe have been discussed (see, for example, Non-patent Literatures 2 to 8). This discussion includes a discussion about relay selection criteria for selecting a ProSe UE-to-Network Relay and a ProSe UE-to-UE Relay and a discussion about a relay selection procedure including arrangement of a relay selection. Note that, the ProSe UE-to-UE Relay is a UE that relays traffic between two remote UEs.

Regarding the arrangement of the relay selection for the UE-to-Network Relay, a distributed relay selection architecture in which a remote UE selects a relay (see, for example, Non-patent Literatures 3-5, 7 and 8) and a centralized relay selection architecture in which an element in a network such as a base station (i.e., eNodeB (eNB)) selects a relay (see, for example, Non-patent Literatures 6 and 7) have been proposed. Regarding the criteria for the relay selection for the UE-to-Network Relay, it has been proposed to consider D2D link quality between a remote UE and a relay UE, consider backhaul link quality between a relay UE and an eNB, and consider both the D2D link quality and the backhaul link quality (see, for example, Non-patent Literatures 3 to 8).

For example, Non-patent Literature 3 to 5 discloses that both D2D link quality and backhaul link quality are considered in the distributed relay selection. In an example, a remote UE considers both the D2D link quality and the backhaul link quality by using an evaluation formula, i.e., w*D2D link quality+(1−w)*backhaul link quality, where w is a predefined constant (see Non-Patent Literature 3). In some implementations, a relay UE transmits a discovery message indicating radio quality of a backhaul link (i.e., between the relay UE and an eNB) to assist relay selection performed by a remote UE (see Non-Patent Literature 4). Alternatively, a relay UE may implicitly indicate radio quality of a backhaul link to a remote UE to assist relay selection performed by the remote UE. For example, priority information in a discovery signal is used to implicitly indicate the radio quality of the backhaul link (see Non-Patent Literature 5).

For example, Non-patent Literature 6 states that both D2D link quality and backhaul link quality are considered in the centralized relay selection. In an example, a remote UE reports D2D link quality to an eNB and the eNB selects a relay for the remote UE while considering the reported D2D link quality and (reported) backhaul link quality. The backhaul link quality may be acquired by a measurement performed by the eNB or by measurement reporting by the relay UE in an existing cellular network.

For example, in Non-Patent Literature 7 and 8, an eNB selects one or more relay candidate UEs while taking into account backhaul link quality. Only these relay candidate UEs can be found by the remote UE in the relay discovery procedure. The remote UE selects a relay from among the one or more relay candidates based on the D2D link quality. Since the backhaul link quality is considered in the selection of the relay candidates performed by the eNB, it is also indirectly considered in the relay selection performed by the remote UE.

In the specification, a radio terminal having the D2D communication capability and the relay capability, such as the ProSe UE-to-Network Relay and the ProSe UE-to-UE Relay, is referred to as a “relay radio terminal” or a “relay UE”. Further, a radio terminal that receives a relay service provided by a relay UE is referred to as a “remote radio terminal” or a “remote UE”.

### CITATION LIST

### Non Patent Literature

Non-Patent Literature 1: 3GPP TS 23.303 V13.2.0 (2015-December), “3rd Generation Partnership Project; Technical Specification Group Services and System Aspects; Proximity-based services (ProSe); Stage 2 (Release 13)”, December 2015

Non-Patent Literature 2: 3GPP TR 23.713 V13.0.0 (2015-September), “3rd Generation Partnership Project; Technical Specification Group Services and System Aspects; Study on extended architecture support for proximity-based services (Release 13)”, September 2015

Non-Patent Literature 3: 3GPP R1-152778, “Support of UE-Network relays”, Qualcomm Incorporated, May 2015

Non-Patent Literature 4: 3GPP S2-150925, “UE-to-Network Relay conclusions”, Qualcomm Incorporated, April 2015

Non-Patent Literature 5: 3GPP R1-153087, “Discussion on UE-to-Network Relay measurement”, Sony, May 2015

Non-Patent Literature 6: 3GPP R2-152560, “Role of eNB when remote UE is in coverage”, Qualcomm Incorporated, May 2015

Non-Patent Literature 7: 3GPP R1-151965, “Views on UE-to-Network Relay Discovery”, NTT DOCOMO, April 2015

Non-Patent Literature 8: 3GPP R1-153188, “Discussion on Relay Selection”, NTT DOCOMO, May 2015

### SUMMARY OF INVENTION

### Technical Problem

The inventors have studied a relay selection, found several problems including three problems specifically described below, and conceived some improvements to address these problems.

For example, Non-patent Literature 3 to 8 describes that either or both of D2D link quality and backhaul link quality is considered in a relay selection for a remote UE. Specifically, Non-patent Literature 3 describes that specific examples of the backhaul link quality includes a downlink (DL) Reference Signal Received Power (RSRP) and a DL Signal-to-Interference plus Noise Ratio (SINR), and that the DL RSRP or DL SINR of the backhaul link is considered in a relay selection. However, Non-patent Literature 3 to 8 does not explicitly teach that quality of uplink transmission from a relay UE to an eNB is considered in a relay selection. A plurality of relay UEs may have different uplink transmission capabilities (e.g., maximum transmission powers). For example, LTE ProSe specifies a high power UE for public safety. A high power UE uses EUTRA Band 14 and has maximum transmission power of 31 dBm or 33 dBm. A high power UE may be able to provide better uplink throughput than a normal power UE (i.e., maximum transmission power of 23 dBm). However, it is difficult to preferentially select a high power UE for a remote UE in a relay selection by considering only the DL quality (e.g., DL RSRP, DL Reference Signal Received Quality (RSRQ), or DL SINR) of a backhaul link.

Further, Non-patent Literature 3 to 8 does not teach that a load of a relay UE is considered in a relay selection. The relay UE is connected to a plurality of remote UEs and relays data of these remote UEs. As the number of remote UEs connected to the relay UE increases, effective throughput that the relay UE can provide to each of the remote UEs may decrease. Accordingly, it may be difficult to select a relay UE suitable for a remote UE in a relay selection by considering only the radio quality of a backhaul link and the radio quality of D2D.

Further, Non-patent Literature 1 to 8 describe that a remote UE performs a relay selection. However, for example, when both the remote UE and the relay UE are in-coverage, it might be more efficient to have the network (e.g., an eNB or a ProSe function) perform relay selection than to have the remote UE perform relay selection. However, when both the eNB and the remote UE have a relay selecting function, it is necessary to prepare a control procedure for arbitrating which of these two relay selecting functions should be activated.

In view of the above, one of the objects to be attained by embodiments disclosed herein is to provide an apparatus, a method, and a program that contribute to facilitating a relay selection in which a load of a relay UE is considered. It should be noted that this object is merely one of the objects to be attained by the embodiments disclosed herein. Other objects or problems and novel features will be apparent from the following description and the accompanying drawings.

### Solution to Problem

In a first aspect, a relay selecting apparatus includes a memory, and at least one processor coupled to the memory. The at least one processor is configured to select at least one specific relay terminal suitable for a first remote terminal from among one or more relay terminals while considering the number of other remote terminals connected to or communicating with each relay terminal. Each specific relay terminal is configured to relay traffic between the first remote terminal and a base station through a device-to-device (D2D) link between the specific relay terminal and the first remote terminal and through a backhaul link between the specific relay terminal and the base station.

In a second aspect, a relay selecting method includes selecting at least one specific relay terminal suitable for a first remote terminal from among one or more relay terminals while considering the number of other remote terminals connected to or communicating with each relay terminal. Each specific relay terminal is configured to relay traffic between the first remote terminal and a base station through a device-to-device (D2D) link between the specific relay terminal and the first remote terminal and through a backhaul link between the specific relay terminal and the base station.

In a third aspect, a program includes a set of instructions (software codes) that, when loaded into a computer, causes the computer to perform a method according to the above-described second aspect.

### Advantageous Effects of Invention

According to the above-described aspects, it is possible to provide an apparatus, a method, and a program that contribute to facilitating a relay selection in which a load of a relay UE is considered.

### BRIEF DESCRIPTION OF DRAWINGS

FIG. 1 shows a configuration example of a radio communication network according to some embodiments;

FIG. 2 is a sequence diagram showing an example of a procedure for starting a relay operation according to some embodiments;

FIG. 3 is a sequence diagram showing an example of a procedure for starting a relay operation according to some embodiments;

FIG. 4 is a flowchart showing an example of a relay selection procedure according to a first embodiment;

FIG. 5 is a sequence diagram showing an example of a relay selection procedure according to the first embodiment;

FIG. 6 is a sequence diagram showing an example of a relay selection procedure according to the first embodiment;

FIG. 7 is a flowchart showing an example of a relay selection procedure according to a second embodiment;

FIG. 8 is a flowchart showing an example of a relay selection procedure according to a third embodiment;

FIG. 9 is a flowchart showing an example of a relay selection procedure according to the third embodiment;

FIG. 10 is a flowchart showing an example of a relay selection procedure according to a fourth embodiment;

FIG. 11 is a flowchart showing an example of a relay selection procedure according to a fifth embodiment;

FIG. 12 is a sequence diagram showing an example of a procedure for switching between relay selecting entities according to a sixth embodiment;

FIG. 13 is a sequence diagram showing an example of a procedure for switching between relay selecting entities according to the sixth embodiment;

FIG. 14 is a sequence diagram showing an example of a procedure for switching between relay selecting entities according to the sixth embodiment;

FIG. 15 is a block diagram showing a configuration example of a radio terminal according to some embodiments;

FIG. 16 is a block diagram showing a configuration example of a base station according to some embodiments; and

FIG. 17 is a block diagram showing a configuration example of a D2D controller according to some embodiments.

### DESCRIPTION OF EMBODIMENTS

Specific embodiments are described hereinafter in detail with reference to the drawings. The same or corresponding elements are denoted by the same symbols throughout the drawings, and duplicated explanations are omitted as necessary for the sake of clarity.

Each of the embodiments described below can be used individually, or two or more of the embodiments may be appropriately combined with one another. These embodiments include novel features different from one another. Accordingly, these embodiments contribute to attaining objects or solving problems different from one another, and thus contribute to providing advantages different from one another.

### First Embodiment

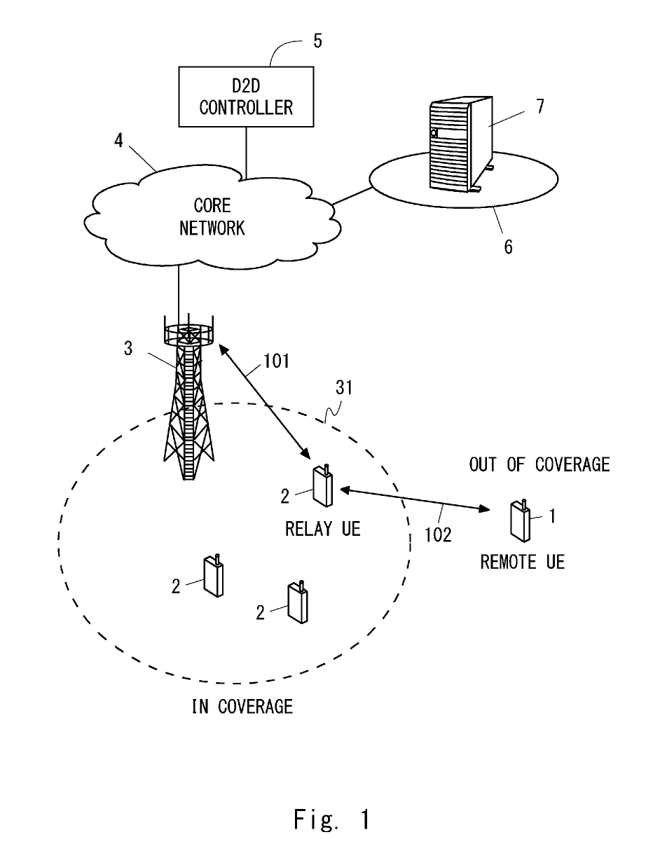

FIG. 1 shows a configuration example of a radio communication network according to some embodiments including this embodiment. Specifically, FIG. 1 shows an example related to a UE-to-Network Relay. That is, a remote UE 1 includes at least one radio transceiver and is configured to perform D2D communication (e.g., ProSe direct discovery and ProSe direct communication) with one or more relay UEs 2 on a D2D link 102 (e.g., PC5 interface or sidelink). Further, though not shown in FIG. 1, the remote UE 1 is configured to perform cellular communication in a cellular coverage 31 provided by one or more base stations 3.

Each relay UE 2 includes at least one radio transceiver and is configured to perform cellular communication with the base station 3 on a cellular link 101 in the cellular coverage 31 and perform D2D communication (e.g., ProSe direct discovery and ProSe direct communication) with the remote UE 1 on the D2D link 102.

The base station 3 is an entity disposed in a radio access network (i.e., E-UTRAN), provides the cellular coverage 31 including one or more cells, and is able to communicate with each relay UE 2 on the cellular link 101 by using a cellular communication technology (e.g., E-UTRA technology). Further, the base station 3 is configured to perform cellular communication with the remote UE 1 when the remote UE 1 is in the cellular coverage 31.

A core network (i.e., Evolved Packet Core (EPC)) 4 includes a plurality of user-plane entities (e.g., Serving Gateway (S-GW) and Packet Data Network Gateway (P-GW)) and a plurality of control-plane entities (e.g., Mobility Management Entity (MME) and Home Subscriber Server (HSS)). The user-plane entities relay user data of the remote UE 1 and user data of the relay UE 2 between an external network and a radio access network including the base station 3. The control-plane entities perform various types of control for the remote UE 1 and the relay UE 2 including mobility management, session management (bearer management), subscriber information management, and billing management.

In some implementations, the remote UE 1 and the relay UE 2 are configured to communicate with a D2D controller 5 through the base station 3 and the core network 4 to use a proximity-based service (e.g., 3GPP ProSe). For example, in the case of 3GPP ProSe, the D2D controller 5 corresponds to a ProSe function entity. The remote UE 1 and the relay UE 2 may use, for example, a network-level discovery (e.g., EPC-level ProSe Discovery) provided by the D2D controller 5, receive from the D2D controller 5 a message indicating a permission for the remote UE 1 and the relay UE 2 to start (or activate) D2D communication (e.g., ProSe direct discovery and ProSe direct communication), or receive from the D2D controller 5 configuration information regarding D2D communication in the cellular coverage 31.

In the example shown in FIG. 1, the relay UE 2 operates as a UE-to-Network Relay and provides the remote UE 1 with a relay operation between the remote UE 1 and the cellular network (i.e., the base station 3 and the core network 4). In other words, the relay UE 2 relays a data flow (traffic) related to the remote UE 1 between the remote UE 1 and the cellular network (i.e., the base station 3 and the core network 4). In this way, the remote UE 1 can communicate with a node 7 located in an external network 6 through the relay UE 2 and the cellular network (i.e., the base station 3 and the core network 4).

In the example shown in FIG. 1, the remote UE 1 is located outside the cellular coverage 31 (i.e., out of coverage). However, as already described, the remote UE 1 may be located within the cellular coverage 31. In some implementations, when the remote UE 1 cannot connect to the cellular network (the base station 3 and the core network 4) under some conditions (e.g., a selection by a user), the remote UE 1 may perform D2D communication (e.g., direct communication) with the relay UE 2. Further, in some implementations, the remote UE 1 may further perform D2D communication with the relay UE 2 while performing cellular communication directly with the base station 3 within the coverage 31 of the base station 3. Further, in some implementations, the remote UE 1 may determine which of the direct cellular communication (hereinafter referred to as a direct path) with the base station 3 and the D2D communication (hereinafter referred to as a relay path) with one of the relay UEs 2 is to be used. The remote UE 1 may autonomously perform switching between the direct path and the relay path, or may perform this switching according to an instruction from the network (e.g., the base station 3 or the D2D controller 5).

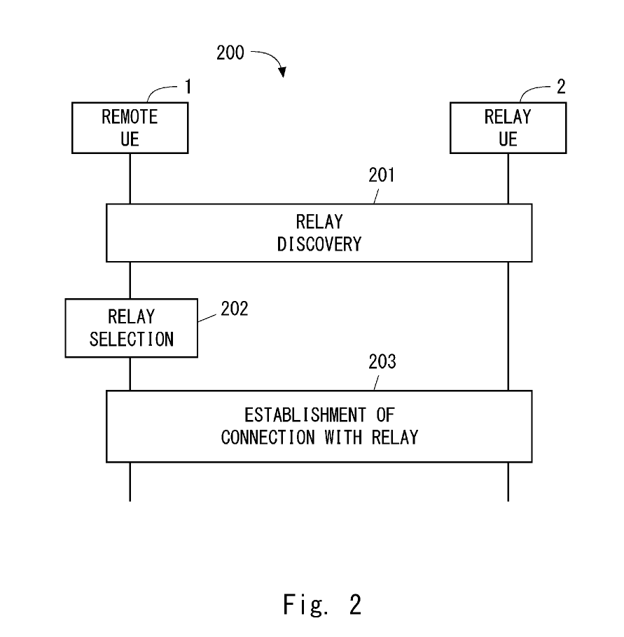

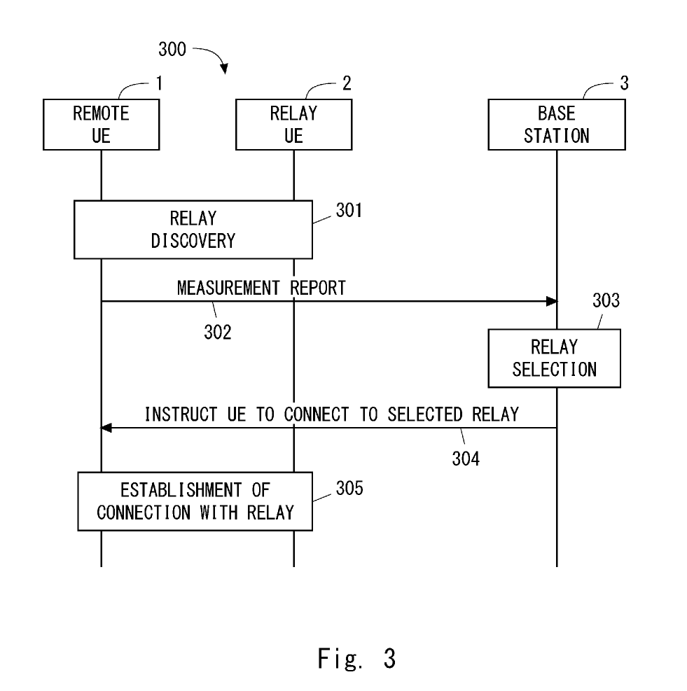

Next, a procedure for starting a relay operation according to some embodiments including this embodiment is described with reference to FIGS. 2 and 3. To start a relay, it is necessary to perform “relay discovery” to find one or more relay UEs 2 that the remote UE 1 can use and also perform a relay selection to select at least one specific relay UE suitable for the remote UE 1 from among the one or more found relay UEs 2. Each of the relay UEs 2 which have not been selected yet can also be referred to as a relay UE candidate. As already described, the relay selection is performed by the remote UE 1 in some implementations (i.e., the distributed relay selection), or it is performed by a network element such as the base station 3 or the D2D controller 5 in other implementations (i.e., the centralized relay selection).

FIG. 2 shows a process 200 that is an example of a procedure according to the distributed relay selection. In Step 201, the remote UE 1 and the relay UE 2 perform a relay discovery procedure so that the remote UE 1 finds the relay UE 2 which serves as a UE-to-Network Relay or a UE-to-UE Relay. For example, in accordance with the so-called announcement model (i.e., model A), the relay UE 2 may transmit a discovery signal and the remote UE 1 may find the relay UE 2 by detecting the discovery signal transmitted from the relay UE 2. Alternatively, in accordance with the so-called solicitation/response model (i.e., model B), the remote UE 1 may transmit a discovery signal indicating that it desires a relay and the relay UE 2 may transmit a response message to this discovery signal to the UE 1, and then the remote UE 1 may find the relay UE 2 by receiving the response message transmitted from the relay UE 2.

In Step 202, the remote UE 1 selects at least one specific suitable relay UE 2 from among the one or more relay UEs 2 found in Step 201. Details of a relay selection procedure according to this embodiment will be described later.

In Step 203, the remote UE 1 establishes a connection for one-to-one D2D communication (i.e., direct communication) with any one of the at least one selected specific relay UE. For example, the remote UE 1 may transmit a direct communication request (or a relay request) to the relay UE 2. Upon receiving the direct communication request (or the relay request), the relay UE 2 may start a procedure for mutual authentication.

Meanwhile, FIG. 3 shows a process 300 that is an example of a centralized relay selection. In Step 301, similarly to Step 201 in FIG. 2, the remote UE 1 and the relay UE 2 perform a relay discovery procedure so that the remote UE 1 finds the relay UE 2 which serves as a UE-to-Network Relay or a UE-to-UE Relay.

In Step 302, the remote UE 1 transmits a measurement report to the base station 3. The measurement report is related to the one or more relay UEs 2 found in Step 301 and includes, for example, a D2D link quality (between the remote UE 1 and the relay UE 2). The D2D link quality may include, for example, at least one of received power, signal-to-interference plus noise ratio (SINR), and data rate (or throughput). Further, similarly to the existing measurement report, the measurement report may include a cellular link quality between the remote UE 1 and the base station 3. Further, the measurement report may include a backhaul link quality (between the base station 3 and the relay UE 2).

In Step 303, the base station 3 selects at least one specific suitable relay UE 2 from among the one or more relay UEs 2 found by the remote UE 1. Details of a relay selection procedure according to this embodiment will be described later.

In Step 304, the base station 3 instructs the remote UE 1 to connect to the selected specific relay UE 2. In Step 305, the remote UE 1 establishes a connection for one-to-one D2D communication (i.e., direct communication) with the specific relay UE according to the instruction from the base station 3.

In the example shown in FIG. 3, the relay selection (step 303) may be performed by a network element other than the base station 3, e.g., by the D2D controller 5.

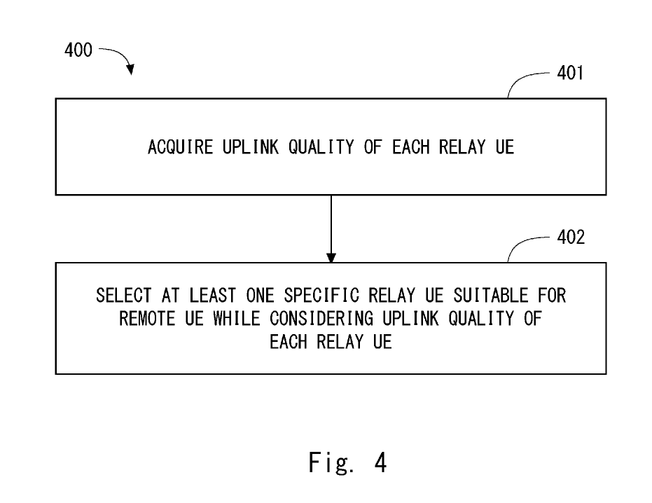

The following provides a specific example of the relay selection procedure according to this embodiment. FIG. 4 is a flowchart showing a process 400 that is an example of the relay selection procedure performed by a relay selecting entity (e.g., the remote UE 1, the base station 3, or the D2D controller 5) according to this embodiment. In Step 401, the relay selecting entity acquires an uplink quality of each of one or more relay UEs 2.

The uplink quality of each relay UE 2 is a quality of uplink transmission from each relay UE 2 to the base station 3. In some implementations, the uplink quality of each relay UE 2 may be an estimated throughput of the uplink transmission. The estimated throughput may be calculated by each relay UE 2 and sent from each relay UE 2 to the relay selecting entity. Alternatively, the estimated throughput may be calculated by the relay selecting entity by using information received from each relay UE 2. For example, in order to estimate the uplink quality of each relay UE, the relay selecting entity may receive, from each relay UE 2, information including: maximum transmission power of each relay UE 2; a downlink-path loss between each relay UE 2 and the base station 3; and uplink radio resources per unit time allocated to each relay UE 2.

In some implementations, the uplink quality of each relay UE 2 may be a Modulation and Coding Scheme (MCS) applied to uplink transmission performed by each relay UE 2. The relay selecting entity may receive, from each relay UE 2 or the base station 3, the uplink MCS applied to each relay UE 2. Alternatively, the relay selecting entity may estimate the uplink MCS applied to each relay UE 2 by using the uplink MCS applied to the remote UE 1, uplink radio resources per unit time allocated to the remote UE 1, maximum transmission power of each relay UE 2, a downlink-path loss of each relay UE 2, and the like.

In some implementations, the uplink quality of each relay UE 2 may be the uplink MCS itself that is applied to each relay UE 2. As described above, the uplink MCS applied to each relay UE 2 may be an estimated value obtained by the relay selecting entity. An uplink throughput of each relay UE 2 can be estimated from the uplink MCS applied to each relay UE 2 and the uplink radio resources per unit time allocated thereto. The uplink MCS applied to each relay UE 2 is thus closely related to the uplink throughput of each relay UE 2.

In some implementations, the uplink quality of each relay UE 2 may be uplink transmission power of each relay UE 2 that is used after transmission power control is performed. An SINR of an uplink signal from each relay UE 2 measured at the base station 3 (i.e., uplink SINR) is dependent on the magnitude of uplink transmission power of each relay UE 2. The uplink transmission power of each relay UE 2 is thus closely related to the uplink throughput of each relay UE 2.

In some implementations, the uplink quality of each relay UE 2 may be power-class information indicating the maximum transmission power of each relay UE 2. As already explained, LTE Prose specifies a high power UE having maximum transmission power of 31 dBm or 33 dBm for public safety. High power UEs having maximum transmission power of 31 dBm or 33 dBm are distinguished from ordinary UEs having maximum transmission power of 23 dBm, based on the UE power class. Specifically, The UE power class assigned to high power UEs is “Class 1” and, accordingly, high power UEs are also referred to as Class-1 UEs or Class-1 devices. Meanwhile, the UE power class for ordinary UEs is “Class 3” and, accordingly, ordinary UEs are also referred to as Class-3 UEs or Class-3 devices. It can be expected that high power UEs can provide a better uplink throughput than UEs having ordinary power (i.e., maximum transmission power of 23 dBm). Accordingly, the relay selecting entity may acquire and use the power-class information of each relay UE 2 in the relay selection.

Referring back to FIG. 4, in Step 402, the relay selecting entity selects at least one specific relay UE 2 suitable for the remote UE 1 while considering the uplink quality of each relay UE 2. The relay selecting entity may select as the specific relay UE(s) 2 for the remote UE 1 at least one relay UE 2 that has relatively high uplink quality from among the one or more relay UEs 2. As described above, the uplink quality of each relay UE 2 may be, for example, (estimated) uplink throughput, an (estimate) uplink MCS, maximum transmission power, or a UE power class.

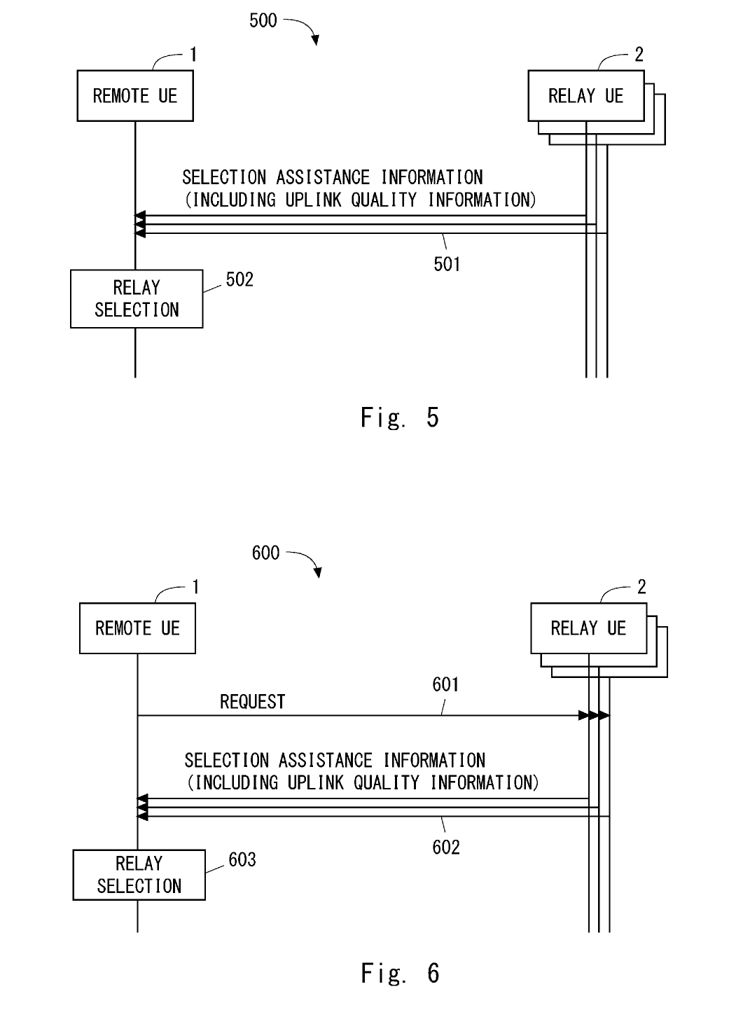

The following provides examples of signaling performed between the remote UE 1 and each relay UE 2 when the remote UE 1 performs a relay selection. FIG. 5 is a sequence diagram showing a process 500 that is an example of a relay selection performed by the remote UE 1. In Step 501, each relay UE 2 notifies the remote UE 1 of selection assistance information. Each relay UE 2 may transmit the selection assistance information in the relay discovery procedure (e.g., in Step 201 in FIG. 2).

Specifically, each relay UE 2 may transmit a discovery signal including the selection assistance information according to the so-called announcement model (i.e., model A). In this way, the remote UE 1 can find relay UEs 2 by detecting their discovery signals and receive the selection assistance information of these relay UEs 2.

The selection assistance information includes uplink quality information of each relay UE 2. The remote UE 1 obtains the uplink quality of each relay UE 2 by using the selection assistance information received from each relay UE 2. In some implementations, the selection assistance information may indicate an uplink throughput estimated by each relay UE 2. Additionally or alternatively, the selection assistance information may indicate maximum transmission power of each relay UE 2 or a power class of each relay UE 2. Additionally or alternatively, the selection assistance information may include a downlink-path loss of each relay UE 2, an uplink MCS of each relay UE 2, uplink radio resources per unit time allocated to each relay UE 2, or any combination thereof.

In Step 502, the remote UE 1 estimates the uplink quality of each relay UE 2 by using the selection assistance information received from each relay UE 2 and performs relay selection while considering the estimated uplink quality of each relay UE 2.

In the example shown FIG. 5, each relay UE 2 has to frequently transmit a radio signal (e.g., a discovery signal) in order to inform the remote UE 1 of the selection assistance information, and thus power consumption of each relay UE 2 could increase. In order to reduce the frequency of transmission of the selection assistance information performed by each relay UE 2, a relay selection procedure (a process 600) shown in FIG. 6 may be used. In Step 601, the remote UE 1 transmits a radio signal including a request for transmission of the selection assistance information. In Step 602, upon receiving the transmission request, each relay UE 2 transmits a radio signal including the selection assistance information to the remote UE 1.

Specifically, the remote UE 1 may transmit a discovery signal including the transmission request for the selection assistance information and each relay UE 2 may transmit a response signal including the selection assistance information to the remote UE 1 according to the so-called solicitation/response model (i.e., model B). In this way, the remote UE 1 can find relay UEs 2 by detecting their response signals and receive the selection assistance information of these relay UEs 2.

The process in Step 603 is similar to that in Step 502 in FIG. 5. Specifically, the remote UE 1 estimates the uplink quality of each relay UE 2 by using the selection assistance information received from each relay UE 2 and performs relay selection while considering the estimated uplink quality of each relay UE 2.

Several specific examples of a method for estimating the uplink quality of each relay UE 2 in the remote UE 1 are described hereinafter. In some implementations, to estimate the uplink quality (e.g., uplink throughput or uplink MCS) of each relay UE 2, the remote UE 1 serving as the relay selecting entity may use the following parameters:
(a) uplink transmission power of the remote UE 1;
(b) a downlink-path loss between the base station 3 and the remote UE 1;
(c) an MCS (an uplink MCS) applied to uplink transmission of the remote UE 1;
(d) maximum transmission power of this relay UE 2; and
(e) a downlink-path loss between the base station 3 and this relay UE 2.

More specifically, the remote UE 1 may estimate an uplink throughput or uplink MCS of each relay UE 2 according to the below-described first or second procedure in which these parameters are used.

### (First Procedure)

In the first step, the remote UE 1 estimates received power (hereinafter referred to as first received power) of an uplink signal from the remote UE 1 at the base station 3 by using: (a) the uplink transmission power of the remote UE 1; and (b) the downlink-path loss between the base station 3 and the remote UE 1.

In the second step, the remote UE 1 calculates an estimated value of interference and noise power at the base station 3 based on the first received power and (c) the uplink MCS of the remote UE 1. Note that, in general, an uplink scheduler of the base station 3 uses an Adaptive Modulation Coding (AMC) table to select an optimum uplink MCS in terms of the uplink throughput. In some implementations, the AMC table is a look-up table that, upon receiving a received SINR (an uplink SINR) at the base station 3, returns an estimated block error rate (BLER) for each MCS. For example, the base station 3 calculates the received SINR of the uplink signal from the remote UE 1 and enters the calculated SINR into the AMC table, thereby acquiring the estimated BLERs of respective MCSs. Then, the base station 3 calculates an expected instantaneous throughput per TTI based on the estimated BLER of each MCS and a Transport Block Size (TBS) of each MCS. After that, the base station 3 selects an MCS that maximizes the instantaneous throughput under the constraint that the estimated BLER is smaller than or equal to the required BLER. The remote UE 1 may therefore have the same AMC table for the MCS selecting algorithm as the base station 3, estimate an uplink SINR corresponding to (c) the uplink MCS of the remote UE 1 that will maximizes the instantaneous throughput, and derive the interference and noise power from the estimated uplink SINR and the above-described first received power.

In the third step, the remote UE 1 estimates the received power (hereinafter referred to as second received power) of the uplink signal from each relay UE 2 at the base station 3 by using (d) and (e) the downlink-path loss of each relay UE 2.

In the fourth step, the remote UE 1 obtains an estimated value of an SINR of the uplink signal from each relay UE 2 at the base station 3 based on the interference and noise power obtained in the second step and the second received power obtained in the third step.

In the fifth step, the remote UE 1 estimates an uplink throughput or uplink MCS of each relay UE 2 based on the estimated value of the SINR obtained in the fourth step.

In some implementations, in this fifth step, the remote UE 1 may obtain the estimated value C of the throughput according to the Shannon capacity formula shown below:

C=BW log₂(1+SINR) (1),

where BW is an uplink communication bandwidth available for the relay UE 2. For the sake of simplicity, the communication bandwidth BW may be based on uplink radio resources (e.g., a bandwidth or the number of resource blocks) per unit time allocated to the remote UE 1.

Alternatively, in the fifth step, the remote UE 1 may estimate an uplink MCS of each relay UE 2 from the estimated value of the SINR obtained in the fourth step, using an AMC table similar to that in the base station 3. The remote UE 1 may multiply the uplink radio resources per unit time in the remote UE 1 or each relay UE 2 by the uplink MCS of each relay UE 2 and, thereby estimating an uplink throughput of each relay UE 2.

### (Second Procedure)

The first step of the second procedure is similar to the first step of the above-described first procedure. Specifically, in the first step, the remote UE 1 estimates received power (hereinafter referred to as first received power) of an uplink signal from the remote UE 1 at the base station 3 by using: (a) the uplink transmission power of the remote UE 1 and; (b) the downlink-path loss between the base station 3 and the remote UE 1.

The second step of the second procedure is similar to the third step of the above-described first procedure. Specifically, the remote UE 1 estimates the received power (hereinafter referred to as second received power) of the uplink signal from each relay UE 2 at the base station 3 by using (d) and (e) the downlink-path loss of each relay UE 2.

In the third step, the remote UE 1 calculates an estimated uplink MCS of each relay UE 2 by correcting (or adjusting) the uplink MCS of the remote UE 1 depending on the difference between the first received power and the second received power. Specifically, when the second received power is larger than the first received power and their difference is larger than a first threshold value, the remote UE 1 obtains the estimated uplink MCS of each relay UE 2 by increasing the uplink MCS of the remote UE 1. In contrast, when the second received power is smaller than the first received power and their difference is larger than a second threshold value, the remote UE 1 obtains the estimated uplink MCS of each relay UE 2 by decreasing the uplink MCS of the remote UE 1. Further, when the second received power is substantially equal to the first received power (i.e., the difference is between the first and second thresholds), the remote UE 1 sets the estimated uplink MCS of each relay UE 2 equal to the value of the uplink MCS of the remote UE 1. Note that, increasing the MCS includes using a higher modulation scheme (i.e., a modulation scheme having a shorter inter-symbol distance), or using a higher coding rate (a smaller number of redundancy bits), or both.

The remote UE 1 may multiply the uplink radio resources per unit time in the remote UE 1 or each relay UE 2 by the uplink MCS of each relay UE 2 obtained in the third step and, thereby estimating an uplink throughput of each relay UE 2.

As understood from the above description, in this embodiment, the relay selecting entity (e.g., the remote UE 1, the base station 3, or the D2D controller 5) considers the uplink quality of each relay UE 2 in the relay selection for the remote UE 1. This, for example, allows the relay selecting entity to select a relay UE 2 that can provide a better uplink throughput to the remote UE 1. The above-described relay selection procedure based on the uplink throughput of the backhaul is especially effective when a plurality of relay UEs 2 have uplink transmission capabilities (e.g., maximum transmission powers) different from each other.

### Second Embodiment

This embodiment provides a modified example of the relay selection procedure described in the first embodiment. In this embodiment, a configuration example of a radio communication network and an example of a relay starting procedure are similar to those shown in FIGS. 1 to 3.

In this embodiment, the relay selecting entity (e.g., the remote UE 1, the base station 3, or the D2D controller 5) considers a D2D link quality between the remote UE 1 and each relay UE 2, as well as the uplink quality of each relay UE 2, in the relay selection for the remote UE 1. The D2D link quality may include, for example, at least one of received power, an SINR, and a data rate (or a throughput) of a radio signal (e.g., a discovery signal) from each relay UE 2 measured by the remote UE 1. Further, similarly to the existing measurement report, the measurement report may include a cellular link quality between the remote UE 1 and the base station 3. Further, the measurement report may include a backhaul link quality (between the base station 3 and the relay UE 2).

For example, to evaluate the communication quality Q of each relay UE 2, the relay selecting entity may use the following Expression (2):

Q=w*D2D link quality+(1−w)*backhaul link quality (2),

where w is a predefined constant. The “backhaul link quality” in Expression (2) includes uplink quality. The “backhaul link quality” in Expression (2) may further include downlink quality.

Alternatively, to evaluate the communication quality Q of each relay UE 2, the relay selecting entity may use the following Expression (3):

Q=MIN (D2D link quality, backhaul link quality) (3),

where the MIN function is a function that returns the minimum value among a plurality of arguments.

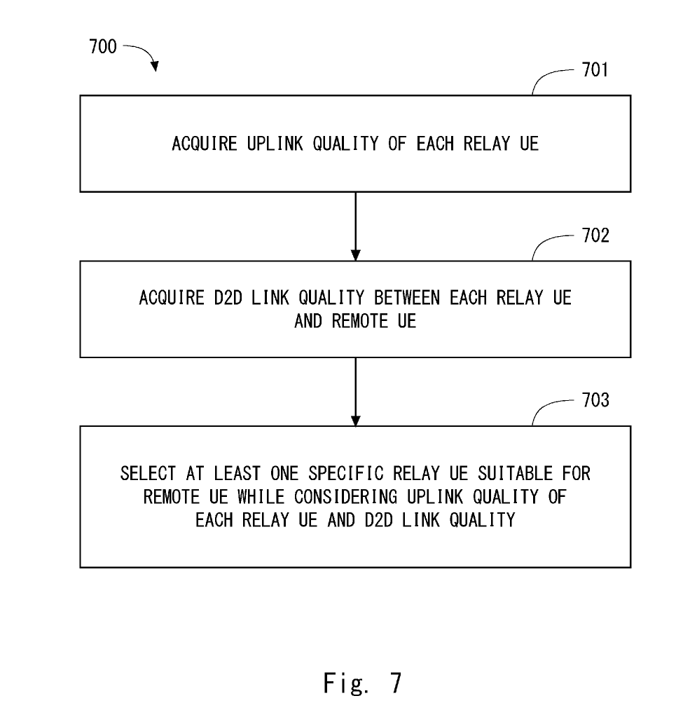

FIG. 7 is a flowchart showing process 700 that is an example of the relay selection procedure performed by the relay selecting entity (e.g., the remote UE 1, the base station 3, or the D2D controller 5) according to this embodiment. The process in Step 701 is similar to that in Step 401 in FIG. 4. Specifically, the relay selecting entity acquires the uplink quality of each of the one or more relay UEs 2. In Step 702, the relay selecting entity acquires the D2D link quality between each relay UE 2 and the remote UE 1. In Step 703, the relay selecting entity selects at least one specific relay UE 2 suitable for the remote UE 1 while considering the uplink quality and the D2D link quality of each relay UE 2. The relay selecting entity may select, as the specific relay UE(s) 2 for the remote UE 1, one or more relay UEs 2 of which the communication quality Q calculated based on the above-shown Expression (2) or (3) is equal to or higher than a predetermined threshold.

As understood from the above description, in this embodiment, the relay selecting entity (e.g., the remote UE 1, the base station 3, or the D2D controller 5) takes into account the uplink quality and the D2D link quality of each relay UE 2 in the relay selection for the remote UE 1. In this way, in the relay selection for the remote UE 1, it is for example possible to lower the priority of a relay UE 2 that can provide sufficient uplink quality, but provide lower D2D link quality than other relay UEs 2.

### Third Embodiment

A configuration example of a radio communication network and an example of a relay starting procedure according to this embodiment are similar to those shown in FIGS. 1 to 3. In this embodiment, the relay selecting entity (e.g., the remote UE 1, the base station 3, or the D2D controller 5) takes into account a load on each relay UE 2 in the relay selection for the remote UE 1. A load on each relay UE 2 may be the number of remote UEs 1 connected to this relay UE 2 (i.e., communicating with this relay UE 2).

As the number of remote UEs 1 connected to one relay UE 2 (or communicating with one relay UE 2) increases, an effective throughput that the relay UE 2 can provide to each of the remote UEs would decrease. The relay selecting entity may therefore preferentially select, for the remote UE 1, a relay UE 2 with which a smaller number of remote UEs 1 are connected or communicating. In this way, the relay selecting entity can select, for a newly-connected remote UE 1, a relay UE 2 that can provide a higher effective throughput to this remote UE 1.

More specifically, when the relay selecting entity evaluates the D2D link quality of each relay UE 2, it may further consider the number of remote UEs 1 connected to this relay UE 2 (or communicating with this relay UE 2). Additionally or alternatively, when the relay selecting entity evaluates the backhaul link quality of each relay UE 2, it may further consider the number of remote UEs 1 connected to this relay UE 2 (or communicating with this relay UE 2). The backhaul link quality may be uplink quality, or downlink quality, or both.

For example, the relay selecting entity may divide the D2D link quality of each relay UE 2 by a divisor (N+1) to evaluate a D2D link quality with which a newly-connected remote UE 1 can be provided by this relay UE 2. Note that, N represents the number of remote UEs 1 connected to each relay UE 2 (i.e., communicating with each relay UE 2). Similarly, the relay selecting entity may divide the backhaul link quality of each relay UE 2 by a divisor (N+1) to evaluate a backhaul link quality with which a newly-connected remote UE 1 can be provided by this relay UE 2.

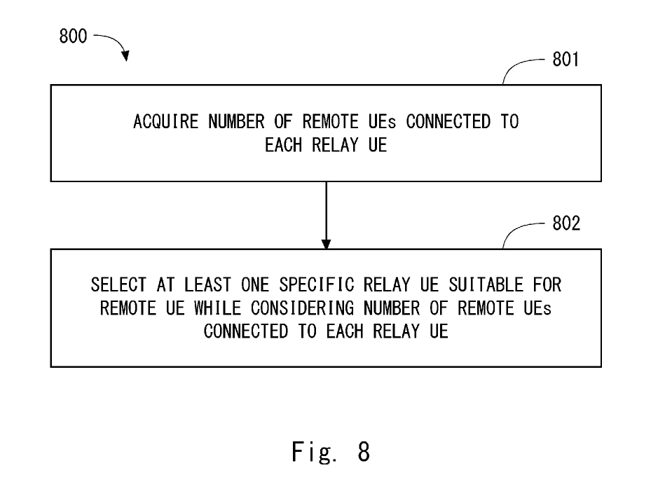

FIG. 8 is a flowchart showing a process 800 that is an example of the relay selection procedure performed by the relay selecting entity (e.g., the remote UE 1, the base station 3, or the D2D controller 5) according to this embodiment. In Step 801, the relay selecting entity acquires the number of remote UEs 1 connected to each relay UE 2 (i.e., communicating with each relay UE 2). For example, the remote UE 1, which serves as the relay selecting entity, may receive, from each relay UE 2, selection assistance information indicating the number of remote UEs 1 connected to or communicating with this relay UE 2 on a D2D link 102.

In Step 802, the relay selecting entity selects at least one specific relay UE 2 suitable for the remote UE 1 while considering the number of remote UEs 1 connected to each relay UE 2 (i.e., communicating with each relay UE 2).

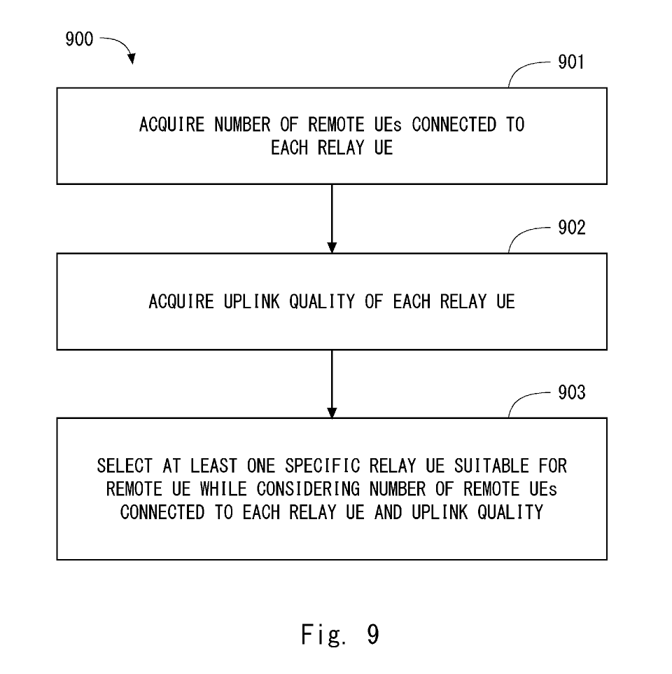

FIG. 9 is a flowchart showing a process 900 that is another example of the relay selection procedure performed by the relay selecting entity according to this embodiment. The process in Step 901 is similar to that in Step 801 in FIG. 8. The process in Step 902 is similar to that in Step 401 in FIG. 4. Specifically, the relay selecting entity acquires the uplink quality of each of the one or more relay UEs 2. The relay selecting entity may simultaneously acquire the number of remote UEs 1 (step 901) and the uplink quality (step 902). For example, the remote UE 1, which serves as the relay selecting entity, may receive selection assistance information indicating both the number of remote UEs 1 and the uplink quality from each relay UE 2 on a D2D link 102.

In Step 903, the relay selecting entity selects at least one specific relay UE 2 suitable for the remote UE 1 while considering both the number of remote UEs 1 connected to each relay UE 2 and the uplink quality of each relay UE 2. As already described, for example, the relay selecting entity may divide the D2D link quality of each relay UE 2 by a divisor (N+1) to evaluate a backhaul link quality with which a newly-connected remote UE 1 can be provided by this relay UE 2.

### Fourth Embodiment

A configuration example of a radio communication network and an example of a relay starting procedure according to this embodiment are similar to those shown in FIGS. 1 to 3. In this embodiment, the relay selecting entity (e.g., the remote UE 1, the base station 3, or the D2D controller 5) further considers a quality of a direct radio link established between the remote UE 1 and the base station 3, and determines which of the direct radio link and a relay path traversing any one of the relay UEs 2 is to be used for communication performed by the remote UE 1. Specifically, the relay selecting entity may determine that the direct radio link should be used for communication performed by the remote UE 1 when the quality (e.g., an estimated throughput) of the direct radio link is higher than the quality (e.g., an estimated throughput) of the relay path traversing any one of the relay UEs 2. In this way, it is possible to select an optimal path for the remote UE 1 from among the relay paths and the direct radio link.

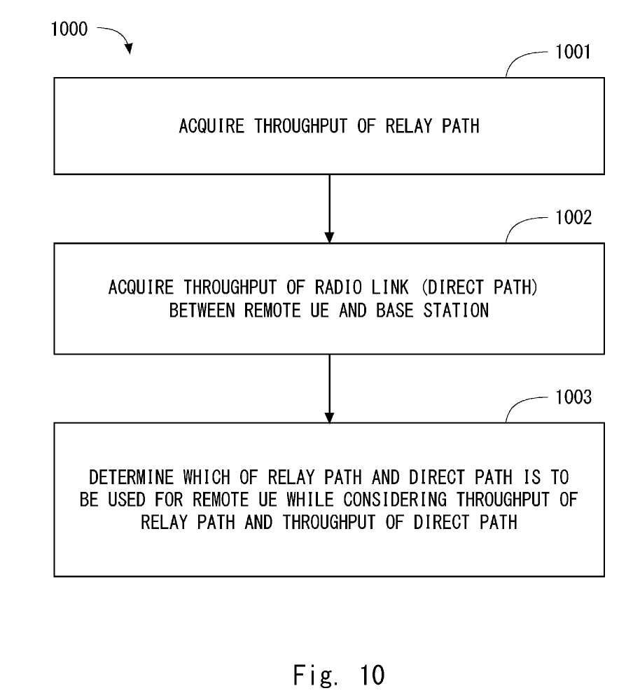

FIG. 10 is a flowchart showing a process 1000 that is an example of the relay selection procedure performed by the relay selecting entity (e.g., the remote UE 1, the base station 3, or the D2D controller 5) according to this embodiment. In Step 1001, the relay selecting entity acquires a throughput of each relay path. The throughput of each relay path may be an estimated throughput of a D2D link, an estimated throughput of a backhaul link (an uplink, or a downlink, or both), or a combination thereof. In Step 1002, the relay selecting entity acquires a throughput of the direct radio link (i.e., the direct path) between the remote UE and the base station 3. The throughput of the direct path may be a throughput of an uplink, or a throughput of a downlink, or both.

In Step 1003, the relay selecting entity determines which one of the relay path(s) and the direct path is to be used for the remote UE 1 while considering the throughput(s) of the relay path(s) and that of the direct path. Specifically, the relay selecting entity may compare the estimated throughputs of the one or more relay paths and the direct path and select a path corresponding to the best estimated throughput for the remote UE 1.

### Fifth Embodiment

This embodiment provides a modified example of the relay selection procedures described in the first to fourth embodiments. A configuration example of a radio communication network and an example of a relay starting procedure according to this embodiment are similar to those shown in FIGS. 1 to 3.

In this embodiment, the remote UE 1 can communicate with a plurality of relay UEs 2 by simultaneously using a plurality of D2D links. Further, the relay selecting entity (e.g., the remote UE 1, the base station 3, or the D2D controller 5) selects a plurality of specific relay UEs 2 for the remote UE 1 to achieve a throughput required for the remote UE 1. The relay selecting entity may select two or more paths for the remote UE 1 from among a plurality of paths including one or more relay paths and a direct path between the remote UE and the base station 3. In this way, when a throughput of each path is smaller than the throughput required for the remote UE 1, the required throughput can be achieved by simultaneously using a plurality of paths.

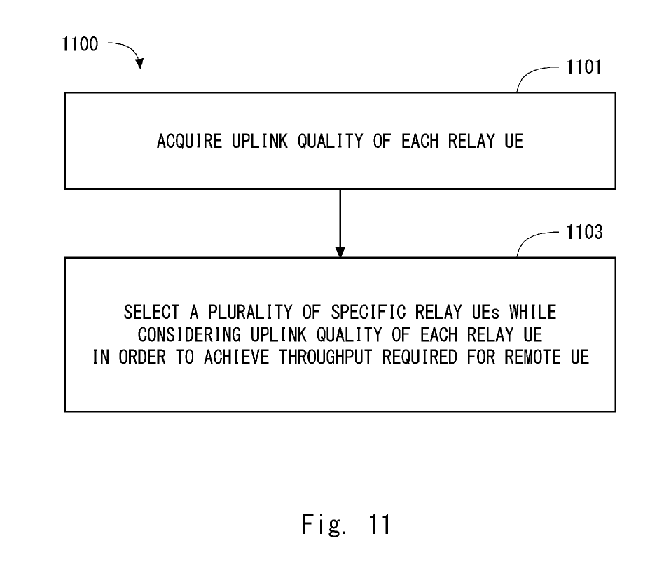

FIG. 11 is a flowchart showing a process 1100 that is an example of the relay selection procedure performed by the relay selecting entity (e.g., the remote UE 1, the base station 3, or the D2D controller 5) according to this embodiment. In Step 1101, the relay selecting entity acquires an uplink quality of each relay UE 2. In Step 1102, the relay selecting entity selects a plurality of specific relay UEs 2 for the remote UE 1 while considering the uplink quality of each relay UE 2 to achieve a throughput required for the remote UE 1. Note that, as understood from the above descriptions, a parameter(s) related to the communication quality of each relay UE 2 acquired in Step 1101 and considered in Step 1102 may be an uplink quality, a downlink quality, a D2D link quality, a load on the relay UE 2, or any combination thereof.

### Sixth Embodiment

A configuration example of a radio communication network and an example of a relay starting procedure according to this embodiment are similar to those shown in FIGS. 1 to 3. This embodiment provides a control procedure which is used, when both of the remote UE 1 and the network (e.g., the base station 3 or the D2D controller 5) have a relay selecting function, to arbitrate which of these two relay selecting functions is to be activated.

In this embodiment, when the remote UE 1 is located in a cellular coverage 31 of the base station 3, the relay selecting entity disposed in the network (e.g., the base station 3 or the D2D controller 5) is preferentially used over the relay selecting entity of the remote UE 1. When the radio link quality between the remote UE 1 and the base station 3 deteriorates, the relay selecting function of the remote UE 1 is activated and the authority to perform a relay selection is transferred from the network to the remote UE 1.

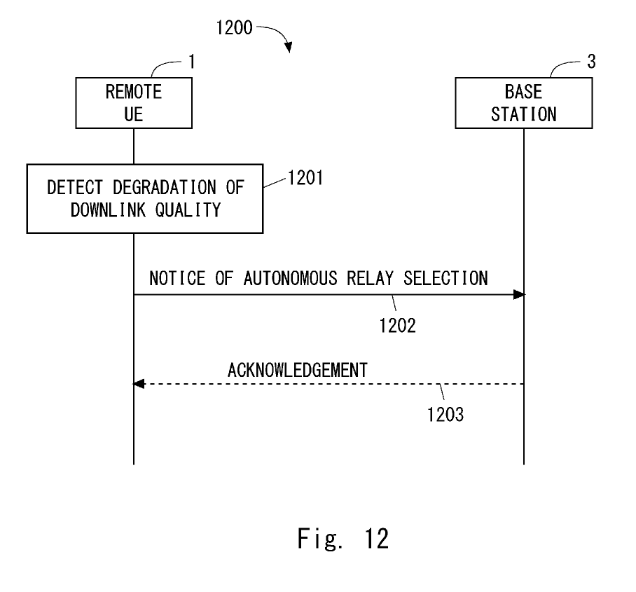

FIG. 12 is a flowchart showing a process 1200 that is an example of a procedure for switching between relay selecting entities. In Step 1201, the remote UE 1 detects degradation of downlink quality (e.g., DL RSRP, DL RSRQ, or DL SINR). For example, the remote UE 1 may detect that the downlink quality is lower than a predetermined threshold. In Step 1202, the remote UE 1 activates an autonomous relay selection performed by the remote UE 1 itself and notifies the base station 3 of the activation of the autonomous relay selection. In Step 1203, upon receiving the notification in Step 1202, the base station 3 may transmit an acknowledgment to the remote UE 1.

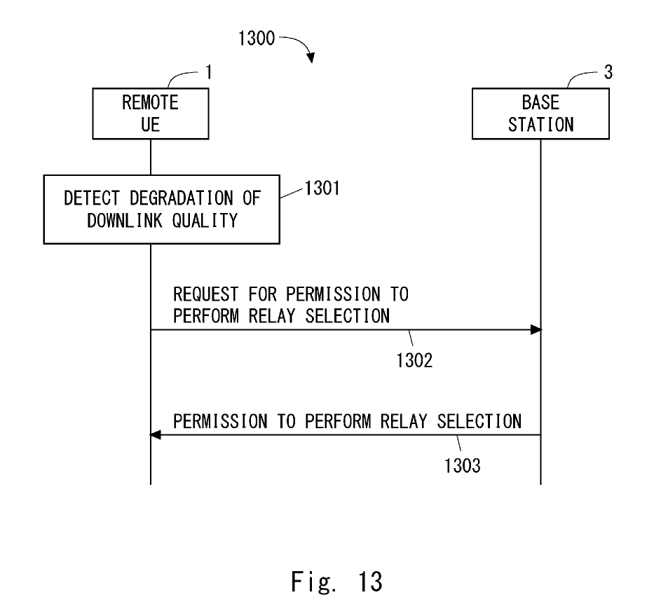

FIG. 13 is a flowchart showing a process 1300 that is another example of a procedure for switching between relay selecting entities. The process in Step 1301 is similar to that in Step 1201 in FIG. 12. In Step 1302, the remote UE 1 transmits, to the base station 3, a request message requesting a permission to perform a relay selection. Upon receiving the request message from the remote UE 1, the base station 3 determines whether to activate the relay selection performed by the remote UE 1. When the base station 3 permits the activation of the relay selection, it transmits a permission to perform the relay selection to the remote UE 1 (step 1303). Upon receiving the permission to perform the relay selection, the remote UE 1 activates the autonomous relay selection performed by the remote UE 1 itself.

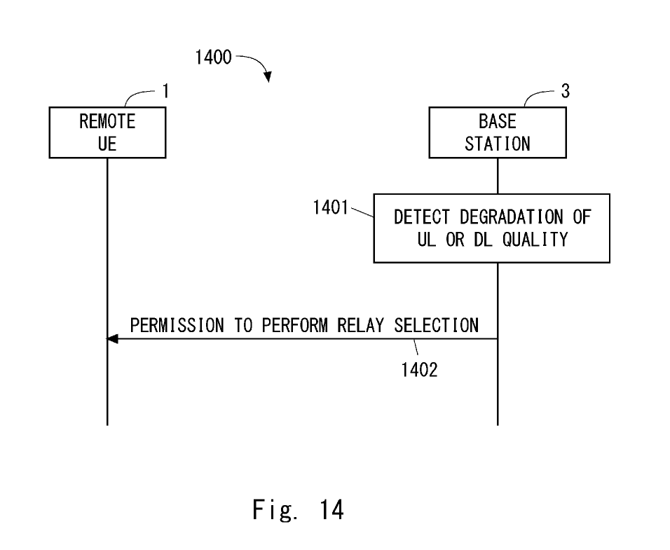

FIG. 14 is a flowchart showing a process 1400 that is still another example of a procedure for switching between relay selecting entities. In Step 1401, the base station 3 detects degradation of the uplink or downlink quality of the remote UE 1. For example, the base station 3 may detect that the uplink or downlink quality of the remote UE 1 is lower than a predetermined threshold. Upon detecting degradation of the uplink or downlink quality of the remote UE 1, the base station 3 transmits a permission to perform the relay selection to the remote UE 1 (step 1402). Upon receiving the permission to perform the relay selection, the remote UE 1 activates the autonomous relay selection performed by the remote UE 1 itself.

By the procedure for switching between relay selecting entities described in this embodiment, it is possible to arbitrate which of the relay selecting function disposed in the network (e.g., the base station 3 or the D2D controller 5) and the relay selecting function of the remote UE 1 is to be activated.

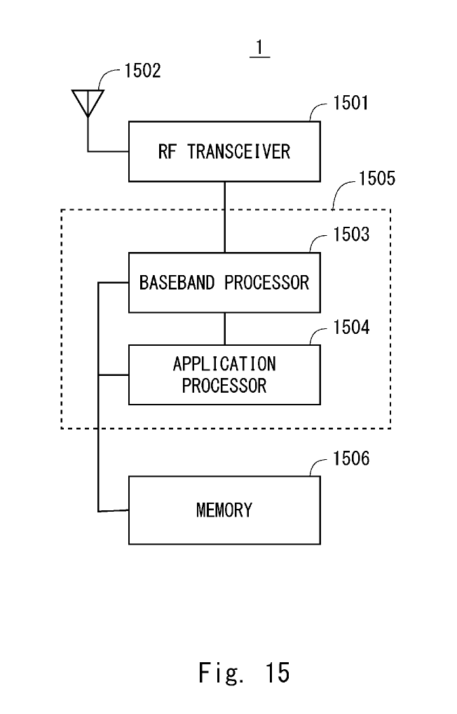

Lastly, configuration examples of the remote UE 1, the relay UE 2, the base station 3, and the D2D controller 5 according to the above-described embodiments will be described. FIG. 15 is a block diagram showing a configuration example of the remote UE 1. The relay UE 2 may have a configuration similar to that shown in FIG. 15. A Radio Frequency (RF) transceiver 1501 performs an analog RF signal processing to communicate with the base station 3. The analog RF signal processing performed by the RF transceiver 1501 includes a frequency up-conversion, a frequency down-conversion, and amplification. The RF transceiver 1501 is coupled to an antenna 1502 and a baseband processor 1503. That is, the RF transceiver 1501 receives modulated symbol data (or OFDM symbol data) from the baseband processor 1503, generates a transmission RF signal, and supplies the generated transmission RF signal to the antenna 1502. Further, the RF transceiver 1501 generates a baseband reception signal based on a reception RF signal received by the antenna 1502 and supplies the generated baseband reception signal to the baseband processor 1503.

The baseband processor 1503 performs digital baseband signal processing (i.e., data-plane processing) and control-plane processing for radio communication. The digital baseband signal processing includes (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). On the other hand, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

For example, in the case of LTE or LTE-Advanced, the digital baseband signal processing performed by the baseband processor 1503 may include signal processing of Packet Data Convergence Protocol (PDCP) layer, Radio Link Control (RLC) layer, MAC layer, and PHY layer. Further, the control-plane processing performed by the baseband processor 1503 may include processing of Non-Access Stratum (NAS) protocol, RRC protocol, and MAC CE.

The baseband processor 1503 may include a modem processor (e.g., Digital Signal Processor (DSP)) that performs the digital baseband signal processing and a protocol stack processor (e.g., Central Processing Unit (CPU) or a Micro Processing Unit (MPU)) that performs the control-plane processing. In this case, the protocol stack processor, which performs the control-plane processing, may be integrated with an application processor 1504 described in the following.

The application processor 1504 may also be referred to as a CPU, an MPU, a microprocessor, or a processor core. The application processor 1504 may include a plurality of processors (processor cores). The application processor 1504 loads a system software program (Operating System (OS)) and various application programs (e.g., voice call application, WEB browser, mailer, camera operation application, and music player application) from a memory 1506 or from another memory (not shown) and executes these programs, thereby providing various functions of the remote UE 1.

In some implementations, as represented by a dashed line (1505) in FIG. 15, the baseband processor 1503 and the application processor 1504 may be integrated on a single chip. In other words, the baseband processor 1503 and the application processor 1504 may be implemented in a single System on Chip (SoC) device 1505. A SoC device may be referred to as a system Large Scale Integration (LSI) or a chipset.

The memory 1506 is a volatile memory, a nonvolatile memory, or a combination thereof. The memory 1506 may include a plurality of memory devices that are physically independent from each other. The volatile memory is, for example, a Static Random Access Memory (SRAM), a Dynamic RAM (DRAM), or a combination thereof. The non-volatile memory is, for example, a mask Read Only Memory (MROM), an Electrically Erasable Programmable ROM (EEPROM), a flash memory, a hard disc drive, or any combination thereof. The memory 1506 may include, for example, an external memory device that can be accessed by the baseband processor 1503, the application processor 1504, and the SoC 1505. The memory 1506 may include an internal memory device that is integrated in the baseband processor 1503, the application processor 1504, or the SoC 1505. Further, the memory 1506 may include a memory in a Universal Integrated Circuit Card (UICC).

The memory 1506 may store software modules (computer programs) including instructions and data to perform processing by the remote UE 1 described in the above embodiments. In some implementations, the baseband processor 1503 or the application processor 1504 may be configured to load the software modules from the memory 1506 and execute the loaded software modules, thereby performing the processing of the remote UE 1 described in the above embodiments with reference to the sequence diagrams and the flowcharts.

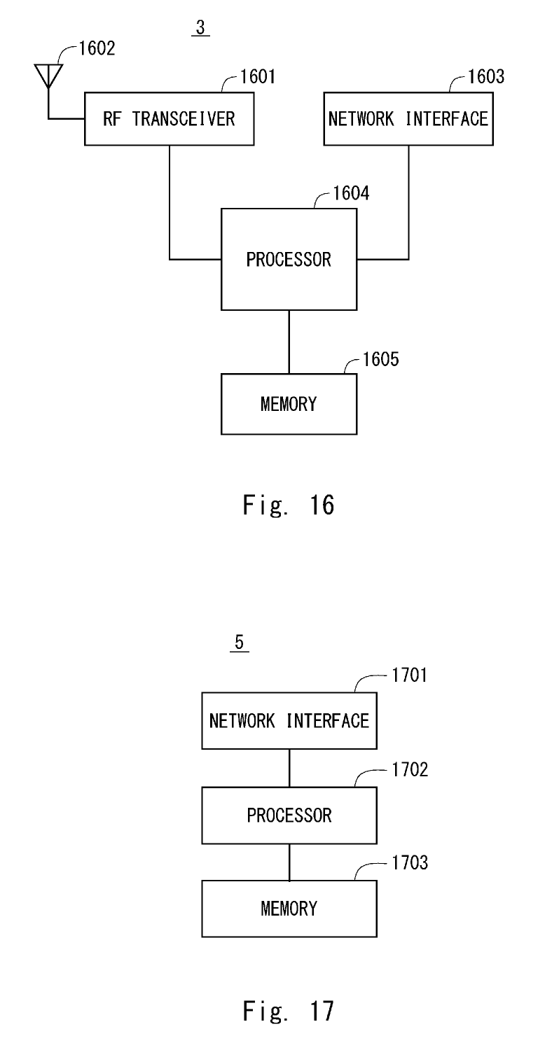

FIG. 16 is a block diagram showing a configuration example of the base station 3 according to the above-described embodiments. As shown in FIG. 16, the base station 3 includes an RF transceiver 1601, a network interface 1603, a processor 1604, and a memory 1605. The RF transceiver 1601 performs analog RF signal processing to communicate with the remote UE 1 and the relay UE 2. The RF transceiver 1601 may include a plurality of transceivers. The RF transceiver 1601 is connected to an antenna 1602 and the processor 1604. The RF transceiver 1601 receives modulated symbol data (or OFDM symbol data) from the processor 1604, generates a transmission RF signal, and supplies the generated transmission RF signal to the antenna 1602. Further, the RF transceiver 1601 generates a baseband reception signal based on a reception RF signal received by the antenna 1602 and supplies this signal to the processor 1604.

The network interface 1603 is used to communicate with a network node (e.g., Mobility Management Entity (MME) and Serving Gateway (S-GW)). The network interface 1603 may include, for example, a network interface card (NIC) conforming to the IEEE 802.3 series.

The processor 1604 performs digital baseband signal processing (data-plane processing) and control-plane processing for radio communication. For example, in the case of LTE or LTE-Advanced, the digital baseband signal processing performed by the processor 1604 may include signal processing of the PDCP layer, RLC layer, MAC layer, and PHY layer. Further, the control-plane processing performed by the processor 1604 may include processing of 51 protocol, RRC protocol, and MAC CE.

The processor 1604 may include a plurality of processors. For example, the processor 1604 may include a modem-processor (e.g., DSP) that performs the digital baseband signal processing, and a protocol-stack-processor (e.g., CPU or MPU) that performs the control-plane processing.

The memory 1605 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disk drive, or a combination thereof. The memory 1605 may include a storage located apart from the processor 1604. In this case, the processor 1604 may access the memory 1605 through the network interface 1603 or an I/O interface (not shown).

The memory 1605 may store software modules (computer programs) including instructions and data to perform processing by the base station 3 described in the above embodiments. In some implementations, the processor 1604 may be configured to load the software modules from the memory 1605 and execute the loaded software modules, thereby performing the processing of the base station 3 described in the above embodiments with reference to the sequence diagrams and the flowcharts.

FIG. 17 is a block diagram showing a configuration example of the D2D controller 5 according to the above-described embodiments. As shown in FIG. 17, the D2D controller 5 includes a network interface 1701, a processor 1702, and a memory 1703. The network interface 1701 is used to communicate with the remote UE 1 and the relay UE 2. The network interface 1701 may include, for example, a network interface card (NIC) conforming to the IEEE 802.3 series.

The processor 1702 loads software (i.e., computer program(s)) from the memory 1703 and executes the loaded software, thereby performing processing of the D2D controller 5 described by using the sequence diagrams and the flowcharts in the above embodiments. The processor 1702 may be, for example, a microprocessor, an MPU, or a CPU. The processor 1702 may include a plurality of processors.

The memory 1703 is composed of a combination of a volatile memory and a nonvolatile memory. The memory 1703 may include a storage located apart from the processor 1702. In this case, the processor 1702 may access the memory 1703 through an I/O interface (not shown).

In the example shown in FIG. 17, the memory 1703 is used to store software modules including a control module for D2D communication. The processor 1702 loads the software module from the memory 1605 and executes the loaded software module, thereby performing the processing of the D2D controller 5 described by in the above embodiments.

As described above with reference to FIGS. 15 to 17, each of the processors included in the remote UE 1, the relay UE 2, the base station 3, and the D2D controller 5 in the above embodiments executes one or more programs including a set of instructions to cause a computer to perform an algorithm described above with reference to the drawings. These programs may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), CD-R, CD-R/W, and a semiconductor memory (such as a mask ROM, a Programmable ROM (PROM), an Erasable PROM (EPROM), a flash ROM, and a Random Access Memory (RAM)). These programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

### Other Embodiments

Each of the above embodiments may be used individually, or two or more of the embodiments may be appropriately combined with one another.

Further, the above-described embodiments are merely examples of applications of the technical ideas obtained by the inventors. These technical ideas are not limited to the above-described embodiments and various modifications can be made thereto.

For example, the whole or part of the embodiments disclosed above can be described as, but not limited to, the following supplementary notes.

### (Supplementary Note A1)

A relay selecting apparatus comprising:

a memory; and

at least one processor coupled to the memory and configured to select at least one specific relay terminal suitable for a first remote terminal from among one or more relay terminals while considering a quality of uplink transmission from each of the one or more relay terminals to a base station, each specific relay terminal being configured to relay traffic between the first remote terminal and the base station through a device-to-device (D2D) link between the specific relay terminal and the first remote terminal and through a backhaul link between the specific relay terminal and the base station.

### (Supplementary Note A2)

The relay selecting apparatus described in Supplementary note A1, wherein the at least one processor is configured to determine the quality of the uplink transmission by using power-class information indicating maximum transmission power of each relay terminal.

### (Supplementary Note A3)

The relay selecting apparatus described in Supplementary note A1 or A2, wherein the at least one processor is configured to calculate the quality of the uplink transmission of each relay terminal by using maximum transmission power of the relay terminal, a downlink-path loss between the base station and the relay terminal, and uplink radio resources per unit time allocated to the relay terminal.

### (Supplementary Note A4)

The relay selecting apparatus described in Supplementary note A1 or A2, wherein the quality of the uplink transmission includes an estimated throughput of the uplink transmission of each relay terminal.

### (Supplementary Note A5)

The relay selecting apparatus described in any one of Supplementary notes A1, A2 and A4, wherein the quality of the uplink transmission includes an estimated value of a Modulation and Coding Scheme (MCS) applied to the uplink transmission of each relay terminal.

### (Supplementary Note A6)

The relay selecting apparatus described in Supplementary note A4 or A5, wherein the at least one processor is configured to calculate an estimated throughput of the uplink transmission of each relay terminal or an estimated MCS applied to the uplink transmission of each relay terminal by using:
(a) uplink transmission power of the first remote terminal;

1(b) a downlink-path loss between the base station and the first remote terminal;
(c) a Modulation and Coding Scheme (MCS) of the first remote terminal;
(d) maximum transmission power of the relay terminal; and
(e) a downlink-path loss between the base station and the relay terminal.

### (Supplementary Note A7)

The relay selecting apparatus described in Supplementary note A6, wherein the at least one processor is configured to:
calculate an estimated value of interference and noise power at the base station by using the uplink transmission power of the first remote terminal, the downlink-path loss between the base station and the first remote terminal, and the MCS of the first remote terminal; and
calculate the estimated MCS or the estimated throughput of each relay terminal by using the estimated value of interference and noise power, the maximum transmission power of the relay terminal, and the downlink-path loss between the base station and the relay terminal.

### (Supplementary Note A8)

The relay selecting apparatus described in Supplementary note A6, wherein the at least one processor is configured to:
calculate first received power of an uplink signal from the first remote terminal at the base station based on the uplink transmission power of the first remote terminal and the downlink-path loss between the base station and the first remote terminal;
calculate second received power of an uplink signal from each relay terminal at the base station by using the maximum transmission power of the relay terminal and the downlink-path loss between the base station and the relay terminal; and
calculate the estimated MCS of each relay terminal by correcting the Modulation and Coding Scheme (MCS) of the first remote terminal depending on a difference between the first received power and the second received power.

### (Supplementary Note A9)

The relay selecting apparatus described in any one of Supplementary notes A1 to A8, wherein the at least one processor is configured to further consider a quality of a D2D link between the first remote terminal and each relay terminal to select the at least one specific relay terminal.

### (Supplementary Note A10)

The relay selecting apparatus described in any one of Supplementary notes A1 to A9, wherein the at least one processor is configured to determine which of a relay path traversing any one of the one or more relay terminals and a direct radio link established between the first remote terminal and the base station is to be used for communication of the first remote terminal by further considering a quality of direct uplink transmission from the first remote terminal to the base station.

### (Supplementary Note A11)

The relay selecting apparatus described in any one of Supplementary notes A1 to A10, wherein
the first remote terminal is configured to perform communication by simultaneously using a plurality of D2D links, and
the at least one processor is configured to select a plurality of specific relay terminals to achieve a throughput required for the first remote terminal.

### (Supplementary Note A12)

The relay selecting apparatus described in any one of Supplementary notes A1 to A11, wherein the at least one processor is configured to consider the number of other remote terminals connected to or communicating with each relay terminal to select the at least one specific relay terminal.

### (Supplementary Note A13)

The relay selecting apparatus described in Supplementary note A12, wherein the at least one processor is configured to preferentially select as the at least one specific relay terminal a relay terminal with which a smaller number of other remote terminals are connected or communicating.

### (Supplementary Note A14)

The relay selecting apparatus described in Supplementary note A12 or A13, wherein the at least one processor is configured to:
estimate an effective throughput that the first remote terminal can use by using an estimated throughput of the uplink transmission of each relay terminal and the number of other remote terminals connected to or communicating with each relay terminal; and
select the at least one specific relay terminal based on the effective throughput.

### (Supplementary Note A15)

The relay selecting apparatus described in any one of Supplementary notes A1 to A14, wherein the relay selecting apparatus is disposed in the first remote terminal.

### (Supplementary Note A16)

A relay selecting method comprising:
selecting at least one specific relay terminal suitable for a first remote terminal from among one or more relay terminals while considering a quality of uplink transmission from each of the one or more relay terminals to a base station, each specific relay terminal being configured to relay traffic between the first remote terminal and the base station through a device-to-device (D2D) link between the specific relay terminal and the first remote terminal and through a backhaul link between the specific relay terminal and the base station.

### (Supplementary Note A17)

The relay selecting method described in Supplementary note A16, further comprising determining the quality of the uplink transmission by using power-class information indicating maximum transmission power of each relay terminal.

(Supplementary note A18)

The relay selecting method described in Supplementary note A16, further comprising calculating the quality of the uplink transmission of each relay terminal by using maximum transmission power of the relay terminal, a downlink-path loss between the base station and the relay terminal, and uplink radio resources per unit time allocated to the relay terminal.

### (Supplementary Note A19)

The relay selecting method described in Supplementary note A16 or A17, wherein the quality of the uplink transmission includes an estimated value of a Modulation and Coding Scheme (MCS) applied to the uplink transmission of each relay terminal.

(Supplementary note A20)

A program for causing a computer to perform a relay selecting method, wherein
the relay selecting method comprising selecting at least one specific relay terminal suitable for a first remote terminal from among one or more relay terminals while considering a quality of uplink transmission from each of the one or more relay terminals to a base station, and
each specific relay terminal is configured to relay traffic between the first remote terminal and the base station through a device-to-device (D2D) link between the specific relay terminal and the first remote terminal and through a backhaul link between the specific relay terminal and the base station.

### (Supplementary Note B1)

A control apparatus disposed in a network including a base station, the control apparatus comprising:
a memory; and
at least one processor coupled to the memory and configured to transmit to a radio terminal a control signal indicating which of the network and the radio terminal should perform a relay selection, wherein
the relay selection comprises selecting at least one specific relay terminal suitable for the radio terminal from among one or more relay terminals, and
each specific relay terminal is configured to relay traffic between the radio terminal and the base station through a device-to-device (D2D) link between the specific relay terminal and the radio terminal and through a backhaul link between the specific relay terminal and the base station.

### (Supplementary Note B2)

The control apparatus described in Supplementary note B1, wherein the at least one processor is configured to transmit the control signal to the radio terminal according to an uplink or downlink communication quality between the radio terminal and the base station.

### (Supplementary Note B3)

The control apparatus described in Supplementary note B2, wherein the at least one processor is configured to, in response to detecting that the uplink or downlink communication quality is lower than a predetermined threshold, transmit to the radio terminal the control signal to indicate that the radio terminal is permitted to perform the relay selection.

### (Supplementary Note B4)

The control apparatus described in any one of Supplementary notes B1 to B3, wherein the at least one processor is configured to transmit the control signal to the radio terminal in response to receiving a request from the radio terminal.

### (Supplementary Note B5)

A method performed in a control apparatus disposed in a network including a base station, the method comprising:
transmitting to a radio terminal a control signal indicating which of the network and the radio terminal should perform a relay selection, wherein
the relay selection comprises selecting at least one specific relay terminal suitable for the radio terminal from among one or more relay terminals, and
each specific relay terminal is configured to relay traffic between the radio terminal and the base station through a device-to-device (D2D) link between the specific relay terminal and the radio terminal and through a backhaul link between the specific relay terminal and the base station.

### (Supplementary Note B6)

The method described in Supplementary note B5, wherein the transmitting comprises transmitting the control signal to the radio terminal according to an uplink or downlink communication quality between the radio terminal and the base station.

### (Supplementary Note B7)

A program for causing a computer to perform a method performed in a control apparatus disposed in a network including a base station, wherein
the method comprises transmitting to a radio terminal a control signal indicating which of the network and the radio terminal should perform a relay selection,
the relay selection comprises selecting at least one specific relay terminal suitable for the radio terminal from among one or more relay terminals, and
each specific relay terminal is configured to relay traffic between the radio terminal and the base station through a device-to-device (D2D) link between the specific relay terminal and the radio terminal and through a backhaul link between the specific relay terminal and the base station.

### (Supplementary Note B8)

A radio terminal comprising:
a memory; and
at least one processor coupled to the memory and configured to receive from a network a control signal indicating which of the network and the radio terminal should perform a relay selection, wherein
the relay selection comprises selecting at least one specific relay terminal suitable for the radio terminal from among one or more relay terminals, and
each specific relay terminal is configured to relay traffic between the radio terminal and a base station in the network through a device-to-device (D2D) link between the specific relay terminal and the radio terminal and through a backhaul link between the specific relay terminal and the base station.

### (Supplementary Note B9)

The radio terminal described in Supplementary note B8, wherein the at least one processor is configured to determine, based on the control signal, whether to perform the relay selection in the radio terminal.

### (Supplementary Note B10)

The radio terminal described in Supplementary note B8 or B9, wherein the at least one processor is configured to, in response to detecting that an uplink or downlink communication quality between the radio terminal and the base station is lower than a predetermined threshold, transmit to the network a request for a permission to perform the relay selection in the radio terminal.

### (Supplementary Note B11)

A method performed in a radio terminal, the method comprising:
receiving from a network a control signal indicating which of the network and the radio terminal should perform a relay selection, wherein
the relay selection comprises selecting at least one specific relay terminal suitable for the radio terminal from among one or more relay terminals, and
each specific relay terminal is configured to relay traffic between the radio terminal and a base station in the network through a device-to-device (D2D) link between the specific relay terminal and the radio terminal and through a backhaul link between the specific relay terminal and the base station.

### (Supplementary Note B12)

The method described in Supplementary note B11, further comprising determining, based on the control signal, whether to perform the relay selection in the radio terminal.

(Supplementary note B13)

The method described in Supplementary note B11 or B12, further comprising in response to detecting that an uplink or downlink communication quality between the radio terminal and the base station is lower than a predetermined threshold, transmitting to the network a request for a permission to perform the relay selection in the radio terminal.

### (Supplementary Note B14)

A program for causing a computer to perform a method performed in a radio terminal, wherein
the method comprises receiving from a network a control signal indicating which of the network and the radio terminal should perform a relay selection,
the relay selection comprises selecting at least one specific relay terminal suitable for the radio terminal from among one or more relay terminals, and
each specific relay terminal is configured to relay traffic between the radio terminal and a base station in the network through a device-to-device (D2D) link between the specific relay terminal and the radio terminal and through a backhaul link between the specific relay terminal and the base station.

### (Supplementary Note B15)

A radio terminal comprising:
a memory; and
at least one processor coupled to the memory and configured to, in response to detecting that an uplink or downlink communication quality between the radio terminal and a base station is lower than a predetermined threshold, transmit, to a network including the base station, a request for a permission to perform a relay selection in the radio terminal or a report indicating that the relay selection is to be performed by the radio terminal, wherein
the relay selection comprises selecting at least one specific relay terminal suitable for the radio terminal from among one or more relay terminals, and
each specific relay terminal is configured to relay traffic between the radio terminal and the base station through a device-to-device (D2D) link between the specific relay terminal and the radio terminal and through a backhaul link between the specific relay terminal and the base station.

### (Supplementary Note B16)

A method performed in a radio terminal, the method comprising:
in response to detecting that an uplink or downlink communication quality between the radio terminal and a base station is lower than a predetermined threshold, transmitting, to a network including the base station, a request for a permission to perform the relay selection in the radio terminal or a report indicating that the relay selection is to be performed by the radio terminal, wherein
the relay selection comprises selecting at least one specific relay terminal suitable for the radio terminal from among one or more relay terminals, and
each specific relay terminal is configured to relay traffic between the radio terminal and the base station through a device-to-device (D2D) link between the specific relay terminal and the radio terminal and through a backhaul link between the specific relay terminal and the base station.

### (Supplementary Note B17)

A program for causing a computer to perform a method in a radio terminal, wherein
the method comprises in response to detecting that an uplink or downlink communication quality between the radio terminal and a base station is lower than a predetermined threshold, transmitting, to a network including the base station, a request for a permission to perform the relay selection in the radio terminal or a report indicating that the relay selection is to be performed by the radio terminal,
the relay selection comprises selecting at least one specific relay terminal suitable for the radio terminal from among one or more relay terminals, and
each specific relay terminal is configured to relay traffic between the radio terminal and the base station through a device-to-device (D2D) link between the specific relay terminal and the radio terminal and through a backhaul link between the specific relay terminal and the base station.

### (Supplementary Note C1)

A relay selecting apparatus comprising:
a memory; and
at least one processor coupled to the memory and configured to select at least one specific relay terminal suitable for a first remote terminal from among one or more relay terminals while considering the number of other remote terminals connected to or communicating with each relay terminal, each specific relay terminal being configured to relay traffic between the first remote terminal and a base station through a device-to-device (D2D) link between the specific relay terminal and the first remote terminal and through a backhaul link between the specific relay terminal and the base station.

### (Supplementary Note C2)

The relay selecting apparatus described in Supplementary note C1, wherein the at least one processor is configured to preferentially select as the at least one specific relay terminal a relay terminal with which a smaller number of other remote terminals are connected or communicating.

### (Supplementary Note C3)

The relay selecting apparatus described in Supplementary note C1 or C2, wherein the at least one processor is configured to further consider a quality of uplink transmission from each relay terminal to the base station to select the at least one specific relay terminal.

### (Supplementary Note C4)

The relay selecting apparatus described in Supplementary note C3, wherein the at least one processor is configured to:
estimate an effective throughput that the first remote terminal can use from an estimated throughput of the uplink transmission of each relay terminal and the number of other remote terminals connected to or communicating with each relay terminal; and
select the at least one specific relay terminal based on the effective throughput.

### (Supplementary Note C5)

The relay selecting apparatus described in Supplementary note C3 or C4, wherein the at least one processor is configured to determine the quality of the uplink transmission by using power-class information indicating maximum transmission power of each relay terminal.

### (Supplementary Note C6)

The relay selecting apparatus described in any one of Supplementary notes C3 to C5, wherein the quality of the uplink transmission includes an estimated value of a Modulation and Coding Scheme (MCS) applied to the uplink transmission of each relay terminal.

### (Supplementary Note C7)

The relay selecting apparatus described in any one of Supplementary notes C1 to C6, wherein the at least one processor is configured to further consider a quality of a D2D link between the first remote terminal and each relay terminal to select the at least one specific relay terminal.

### (Supplementary Note C8)

The relay selecting apparatus described in any one of Supplementary notes C1 to C7, wherein the at least one processor is configured to determine which of a relay path traversing any one of the one or more relay terminals and a direct radio link established between the first remote terminal and the base station is to be used for communication of the first remote terminal by further considering a quality of the direct radio link.

### (Supplementary Note C9)

The relay selecting apparatus described in any one of Supplementary notes C1 to C8, wherein
the first remote terminal is configured to perform communication by simultaneously using a plurality of D2D links, and
the at least one processor is configured to select a plurality of specific relay terminals to achieve a throughput required for the first remote terminal.

### (Supplementary Note C10)

A relay selecting method comprising:
selecting at least one specific relay terminal suitable for a first remote terminal from among one or more relay terminals while considering the number of other remote terminals connected to or communicating with each relay terminal, each specific relay terminal being configured to relay traffic between the first remote terminal and a base station through a device-to-device (D2D) link between the specific relay terminal and the first remote terminal and through a backhaul link between the specific relay terminal and the base station.

### (Supplementary Note C11)

The relay selecting method described in Supplementary note C10, wherein the selecting comprises preferentially selecting as the at least one specific relay terminal a relay terminal with which a smaller number of other remote terminals are connected or communicating.

### (Supplementary Note C12)

The relay selecting method described in Supplementary note C10 or C11, wherein the selecting comprises considering a quality of uplink transmission from each relay terminal to the base station to select the at least one specific relay terminal.

### (Supplementary Note C13)

The relay selecting method described in Supplementary note C12, further comprising estimating an effective throughput that the first remote terminal can use from an estimated throughput of the uplink transmission of each relay terminal and the number of other remote terminals connected to or communicating with each relay terminal, wherein
the selecting comprises selecting the at least one specific relay terminal based on the effective throughput.

### (Supplementary Note C14)

The relay selecting method described in Supplementary note C12 or C13, further comprising determining the quality of the uplink transmission by using power-class information indicating maximum transmission power of each relay terminal.

### (Supplementary Note C15)

The relay selecting method described in any one of Supplementary notes C12 to C14, wherein the quality of the uplink transmission includes an estimated value of a Modulation and Coding Scheme (MCS) applied to the uplink transmission of each relay terminal.

### (Supplementary Note C16)

The relay selecting method described in any one of Supplementary notes C10 to C15, wherein the selecting comprises further considering a quality of a D2D link between the first remote terminal and each relay terminal to select the at least one specific relay terminal.

### (Supplementary Note C17)

The relay selecting method described in any one of Supplementary notes C10 to C16, further comprising determining which of a relay path traversing any one of the one or more relay terminals and a direct radio link established between the first remote terminal and the base station is to be used for communication of the first remote terminal by further considering a quality of the direct radio link.

### (Supplementary Note C18)

The relay selecting method described in any one of Supplementary notes C10 to C17, wherein
the first remote terminal is configured to perform communication by simultaneously using a plurality of D2D links, and
the selecting comprises selecting a plurality of specific relay terminals to achieve a throughput required for the first remote terminal.

### (Supplementary Note C19)

A non-transitory computer readable medium storing a program for causing a computer to perform a relay selecting method, wherein
the relay selecting method comprises selecting at least one specific relay terminal suitable for a first remote terminal from among one or more relay terminals while considering the number of other remote terminals connected to or communicating with each relay terminal, and
each specific relay terminal is configured to relay traffic between the first remote terminal and a base station through a device-to-device (D2D) link between the specific relay terminal and the first remote terminal and through a backhaul link between the specific relay terminal and the base station.

This application is based upon and claims the benefit of priority from Japanese patent application No. 2016-011686, filed on Jan. 25, 2016, the disclosure of which is incorporated herein in its entirety by reference.

### REFERENCE SIGNS LIST

1 REMOTE UE
2 RELAY UE
3 BASE STATION
4 CORE NETWORK
5 DEVICE-TO-DEVICE (D2D) CONTROLLER
6 EXTERNAL NETWORK
7 NODE
1501 RADIO FREQUENCY (RF) TRANSCEIVER
1503 BASEBAND PROCESSOR
1504 APPLICATION PROCESSOR
1506 MEMORY
1604 PROCESSOR
1605 MEMORY
1702 PROCESSOR
1703 MEMORY

1. A relay selecting apparatus comprising:
a memory; and
at least one processor coupled to the memory and configured to select at least one specific relay terminal suitable for a first remote terminal from among one or more relay terminals while considering the number of other remote terminals connected to or communicating with each relay terminal, each specific relay terminal being configured to relay traffic between the first remote terminal and a base station through a device-to-device (D2D) link between the specific relay terminal and the first remote terminal and through a backhaul link between the specific relay terminal and the base station.

2. The relay selecting apparatus according to claim 1, wherein the at least one processor is configured to preferentially select as the at least one specific relay terminal a relay terminal with which a smaller number of other remote terminals are connected or communicating.

3. The relay selecting apparatus according to claim 1, wherein the at least one processor is configured to further consider a quality of uplink transmission from each relay terminal to the base station to select the at least one specific relay terminal.

4. The relay selecting apparatus according to claim 3, wherein the at least one processor is configured to:
estimate an effective throughput that the first remote terminal can use from an estimated throughput of the uplink transmission of each relay terminal and the number of other remote terminals connected to or communicating with each relay terminal; and
select the at least one specific relay terminal based on the effective throughput.

5. The relay selecting apparatus according to claim 3, wherein the at least one processor is configured to determine the quality of the uplink transmission by using power-class information indicating maximum transmission power of each relay terminal.

6. The relay selecting apparatus according to claim 3, wherein the quality of the uplink transmission includes an estimated value of a Modulation and Coding Scheme (MCS) applied to the uplink transmission of each relay terminal.

7. The relay selecting apparatus according to claim 1, wherein the at least one processor is configured to further consider a quality of a D2D link between the first remote terminal and each relay terminal to select the at least one specific relay terminal.

8. The relay selecting apparatus according to claim 1, wherein the at least one processor is configured to determine which of a relay path traversing any one of the one or more relay terminals and a direct radio link established between the first remote terminal and the base station is to be used for communication of the first remote terminal by further considering a quality of the direct radio link.

9. The relay selecting apparatus according to claim 1, wherein
the first remote terminal is configured to perform communication by simultaneously using a plurality of D2D links, and
the at least one processor is configured to select a plurality of specific relay terminals to achieve a throughput required for the first remote terminal.

10. A relay selecting method comprising:
selecting at least one specific relay terminal suitable for a first remote terminal from among one or more relay terminals while considering the number of other remote terminals connected to or communicating with each relay terminal, each specific relay terminal being configured to relay traffic between the first remote terminal and a base station through a device-to-device (D2D) link between the specific relay terminal and the first remote terminal and through a backhaul link between the specific relay terminal and the base station.

11. The relay selecting method according to claim 10, wherein the selecting comprises preferentially selecting as the at least one specific relay terminal a relay terminal with which a smaller number of other remote terminals are connected or communicating.

12. The relay selecting method according to claim 10, wherein the selecting comprises considering a quality of uplink transmission from each relay terminal to the base station to select the at least one specific relay terminal.

13. The relay selecting method according to claim 12, further comprising estimating an effective throughput that the first remote terminal can use from an estimated throughput of the uplink transmission of each relay terminal and the number of other remote terminals connected to or communicating with each relay terminal, wherein
the selecting comprises selecting the at least one specific relay terminal based on the effective throughput.

14. The relay selecting method according to claim 12, further comprising determining the quality of the uplink transmission by using power-class information indicating maximum transmission power of each relay terminal.

15. The relay selecting method according to claim 12, wherein the quality of the uplink transmission includes an estimated value of a Modulation and Coding Scheme (MCS) applied to the uplink transmission of each relay terminal.

16. The relay selecting method according to claim 10, wherein the selecting comprises further considering a quality of a D2D link between the first remote terminal and each relay terminal to select the at least one specific relay terminal.

17. The relay selecting method according to claim 10, further comprising determining which of a relay path traversing any one of the one or more relay terminals and a direct radio link established between the first remote terminal and the base station is to be used for communication of the first remote terminal by further considering a quality of the direct radio link.

18. The relay selecting method according to claim 10, wherein
the first remote terminal is configured to perform communication by simultaneously using a plurality of D2D links, and
the selecting comprises selecting a plurality of specific relay terminals to achieve a throughput required for the first remote terminal.

19. A non-transitory computer readable medium storing a program for causing a computer to perform a relay selecting method, wherein
the relay selecting method comprises selecting at least one specific relay terminal suitable for a first remote terminal from among one or more relay terminals while considering the number of other remote terminals connected to or communicating with each relay terminal, and
each specific relay terminal is configured to relay traffic between the first remote terminal and a base station through a device-to-device (D2D) link between the specific relay terminal and the first remote terminal and through a backhaul link between the specific relay terminal and the base station.
